(19) United States
(12) Patent Application Publication
(10) Pub. No.: US 2014/0094044 A1
(43) Pub. Date: Apr. 3, 2014

(54) PROTECTIVE DEVICE FOR AN ELECTRICAL SOCKET OUTLET

(71) Applicant: Atreus Enterprises Limited, Ballinasloe (IE)

(72) Inventor: Patrick Ward, Ballinasloe (IE)

(73) Assignee: Atreus Enterprises Limited, Ballinasloe (IE)

(21) Appl. No.: 14/027,335

(22) Filed: Sep. 16, 2013

(30) Foreign Application Priority Data
Oct. 1, 2012 (IE) S2012/0436
May 24, 2013 (IE) S2013/0176

(51) Int. Cl. H01R 13/447

(52) U.S. Cl. CPC H01R 13/447
USPC 439/92; 439/142; 439/373

(57) ABSTRACT

A protective device is described for retrofitting to a wall-mounted electrical socket outlet of the kind comprising an open-fronted housing containing at least one electrical socket and a removable front plate screw-fitted to the open front of the housing and having an opening exposing said socket terminals. The protective device comprises a housing which is screw-fittable to the open-fronted socket housing in place of the original front plate and has socket terminals exposed at a front surface. The device includes a hinged flap which can be swung over the exposed socket terminals and there releasably held in place.

### FIELD OF THE DISCLOSURE

This invention relates to a protective device for an electrical socket outlet of the kind comprising a housing containing at least one electrical socket exposed at a front face of the housing.

### BACKGROUND OF THE DISCLOSURE

FIG. 1a is a schematic front perspective view of a typical wall-mounted USA style socket outlet 10 with two 3-terminal sockets 18.

The socket outlet 10 comprises a generally rectilinear housing 12 having a removable front plate 14. The main body 16 of the housing, i.e. the portion behind the front plate 12, contains upper and lower electrical sockets 18 each comprising live L, neutral N and earth E terminals into which a plug can be inserted for connection of a load. The main body 16 of the housing 12 may be a so-called dry lining box or a surface mounted box.

The front plate 14 is moulded from an electrically non-conductive material and is removably fitted to the open-fronted main body 16 of the housing 12 by a screw 21 passing through a screw hole 20. The screw 21 which secures the front plate 12 to the housing 12 is tightened on to a grounded metal plate in the socket outlet to ensure that the screw is always at ground potential and electrically safe. The sockets 18 are mounted within the main body 16 of the housing 12 and remain there when the front plate 14 is removed; thus the front plate consists essentially of a flat plate (Figure lb) with the screw hole 20 and openings 22 exposing the sockets 18.

A disadvantage with socket outlets such as that described above is that it is relatively easy to gain access to and touch a live part, for example by a child inserting a metal hair clip into a socket 18. Such access could give rise to fatal electric shocks. Although there are proposals to introduce future requirement for new receptacles to have shutters fitted in the socket outlet parts to prevent unintended access to the live parts, the above risk will remain with conventional socket outlets. It is estimated that there are more than one billion such socket outlets installed in the USA alone.

An additional problem with conventional socket outlets is that the open terminals provide easy access for moisture which in turn causes corrosion, and access for insects which can cause a fire risk.

There are flaps available on the market that can be inserted into socket outlets to prevent unintended access, but such flaps are fully portable and therefore easily misplaced.

### SUMMARY

According to the present invention there is provided a protective cover plate for fitting to a wall-mounted electrical socket outlet of the kind comprising an open-fronted housing containing at least one electrical socket and which is conventionally fitted with a removable front plate screw-fitted to the open front of the housing and having an opening exposing said socket, the cover plate being screw-fittable to the housing in place of a conventional front plate and likewise exposing said socket, the cover plate including a hinged flap which can be swung over the exposed socket and there releasably secured in place.

The invention further provides a protective device for fitting to a wall-mounted electrical socket outlet, the protective device including a housing which is screw-fittable to the socket outlet and has a multi-pin electrical plug disposed at a rear surface thereof for engaging a socket of the outlet, the protective device further having a socket disposed at a front surface which is electrically connected to the plug internally of the device housing, the device further including a hinged flap which can be swung over the outlet socket and there releasably held in place.

The invention as defined above provides a simple but effective means to mitigate the above and related problems.

The invention further provides a protective device for use with a wall-mounted electrical socket, the protective device comprising a main housing having a multi-pin electrical plug disposed at a first surface for insertion into said wall-mounted electrical socket and an electrical socket disposed at a second surface for receiving an appliance plug, said device plug and socket being connected internally of the main housing by a protection circuit, the main housing further having a screw hole extending therethrough which is axially aligned with a screw hole in the wall-mounted electrical socket when the multi-pin electrical plug disposed at said first surface is fully inserted into the wall-mounted electrical socket, thereby to allow the main housing to be optionally secured to the wall-mounted socket by a screw passing through the main housing into the socket, the protective device further including a sub-housing which is releasably fittable to the main housing to optionally enclose the appliance plug and secure said plug against removal from the electrical socket of the main housing.

Embodiments of the invention will now be described, by way of example, with reference to the accompanying drawings, in which:

### BRIEF DESCRIPTION OF THE DRAWINGS

FIGS. 1a and 1b, previously described, illustrate a prior art US style socket outlet.

FIGS. 2a and 2b are front schematic views of a socket outlet having a protective cover plate according to a first embodiment on the invention, in open and closed states respectively.

FIGS. 3a and 3b are perspective and side views of a second embodiment of the invention.

FIGS. 4a and 4b are front and side views of a third embodiment of the invention in the form of a protective device configured for use as a safety adapter.

FIG. 5 is a perspective view of the third embodiment configured for use as a safety adapter.

FIG. 6 illustrates how the third embodiment configured for use as a safety adapter is fitted to a mains socket outlet.

FIGS. 7a to 7c are perspective views of the third embodiment configured for use as a safety plug.

FIGS. 8a and 8b are perspective views of the third embodiment in use as an adapter and as safety plug, respectively.

FIGS. 9a to 9c show variations of the third embodiment with different pin arrangements.

### DETAILED DESCRIPTION

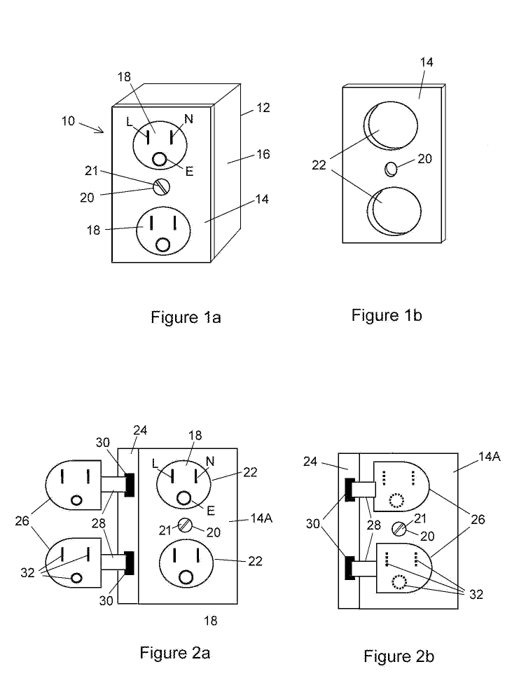

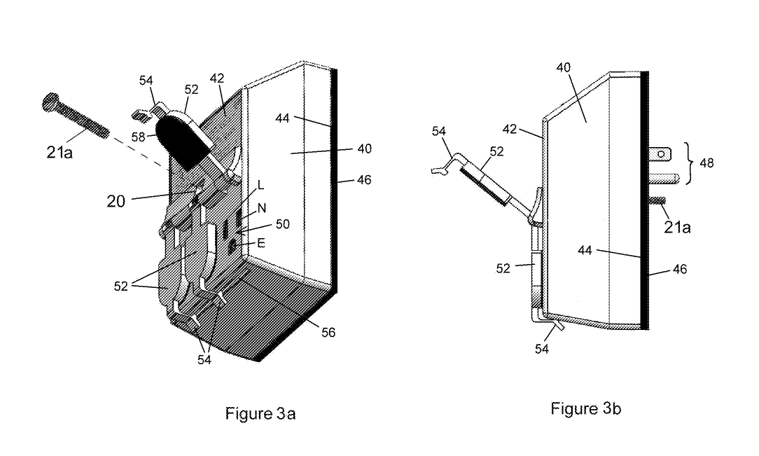

FIGS. 2a and 2b show a first embodiment of the invention. This embodiment comprises a protective cover plate 14A which is screw-fitted to the main body 16 of the housing 12 in substitution for the original front plate 14 of FIGS. 1a and 1b.

One edge of the cover plate 14a is arranged to have a specially prepared strip or section 24 to retain two flaps 26 which are hinged to this strip via respective arms 28. The hinges 30 are preferably formed as living hinges, the flaps 26 and arms 28 being moulded from electrically non-conductive material integrally with the section 24.

Each flap 26 can be swung by rotation about its respective hinge axis from an open position (FIG. 2a) to a closed position (FIG. 2b) where it overlies a respective socket 18. Each flap 26 has a plurality of dummy L, N and E pins 32 moulded on its inside surface which are brought into at least approximate alignment with the socket terminals L, N E as the flap 26 is swung over the respective socket 18 and which can pushed into the socket terminals to close the flap 26 fully against the front plate 14A. The flap 26, arm 28 and/or hinge 30 needs to be flexible at least to some extent to allow sufficient deformation to allow the dummy pins to locate fully in the socket terminals.

The dummy pins 32 are preferably an interference fit in the respective terminals L, N,

E and hold the flap 26 securely in the closed position with sufficient resistance to prevent easy opening by a child. This avoids the need for springs holding the flaps 26 closed, since springs can become weak or fail. Each flap can be left in the closed position indefinitely, preventing unintended access to the terminals and mitigating the aforementioned problems.

In the above arrangement the flaps 26 are secured to the protective cover plate 14A to ensure they are always readily available. Conventional socket outlets can be easily upgraded to this higher level of safety by retrofitting the protective cover plate 14A in place of the standard front plate 14. The replacement front plate also inhibits access for moisture and insects in socket outlets fitted outdoors or in harsh environments, etc.

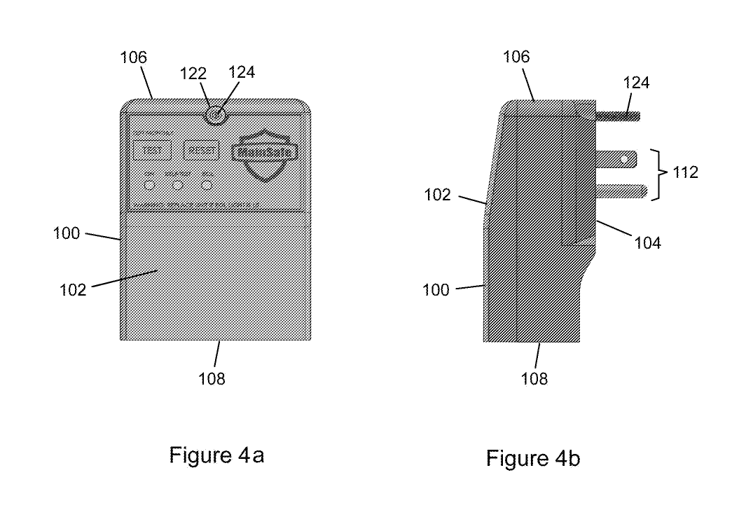

In a modification of the above embodiment, the pins 32 on the flaps 26 can be omitted and replaced in each case by a resilient gasket arranged to seal against the socket terminals L, N and E when the flap is closed. In this case the hinged flap may be releasably secured in place against the terminals L, N and E by a resiliently deformable clip. In such modification the resilient gasket and resiliently deformable clip may be similar to the gasket 58 and clip 54 shown in the embodiment of FIGS. 3a and 3b.

FIGS. 3a and 3b show a protective device according to a second embodiment of the invention. In this case the embodiment takes the form of a multi-outlet socket converter, preferably protected by a ground fault circuit interrupter (GFCI), an arc fault protector, a surge suppressor or other protection circuit.

The protective device comprises a housing 40 having a front surface 42 and a rear surface 44. In use the housing 40 is fitted to the main body 16 of the housing 12 of the US-style socket outlet 10 (FIG. 1A). The housing 40 may be fitted directly to the main body 16 after removal of and in substitution for the original front plate 14. When so fitted, the rear surface 44 of the housing 40 bears against the front edge of the main body 16 via a sealing gasket 46. Alternatively, the housing 40 may be fitted to the socket outlet 10 with the front plate 14 still in position on the main body 16, the housing 40 directly overlying and in register with the front plate 14. In either case the device housing 40 is fitted to the socket outlet 10 using a screw 21a which passes through the hole 20 in the front surface 42 of the housing 40 and emerges from the rear surface 44, see FIG. 3b, to engage the socket outlet 10 in the same way as the screw 21 of the original front plate 14. Naturally the screw 21a is longer than the original screw 21 to allow for the depth of the housing 40 and, as in the case of the screw 21 in FIGS. 1 and 2, the screw 21a is tightened on to a grounded metal plate in the socket outlet 10 to ensure that the screw 21 is electrically safe.

Three terminal pins 48 (only two are visible) project from the rear surface 44 of the housing 40. These engage the upper socket 18 of the outlet 10 when the housing 40 is screw-fitted to the main body 16 as described above. Three electrical sockets 50 (only one is visible) each comprising socket terminals L, N, E are exposed at the front surface 42 of the housing 40; these sockets 50 are connected mutually in parallel to the terminal pins 48 internally of the housing 40 to provide a 1-3 socket converter. The housing 40 preferably contains a protection circuit such as a ground fault circuit interrupter (GFCI), an arc fault protector or a surge suppressor protecting the sockets 50.

Three flaps 52 are hinged to the front surface 42 of the housing 40. Each flap 52 can be individually pivoted from an open position exposing a respective socket 50, as seen for the rightmost flap 52 in FIG. 3a, to a closed position in which the respective socket 50 is covered, as seen for the other two flaps 52 of FIG. 3a. Each flap 52 is releasably held closed by a resiliently deformable clip 54 which is integral with the flap 52 and snap-engages a groove 56 on the underside of the housing 40. Each flap 52 also has a respective gasket 58 on its inside surface for sealing against the terminals L, N, E of the associated socket 50 when the flap is closed.

In a modification of the embodiment of FIG. 3, the gaskets 58 may be omitted and the flaps 52 provided with dummy pins, like the dummy pins 32 of FIG. 2, which are an interference fit in the respective terminals L, N, E of the sockets 50 to hold the flap 52 securely in the closed position. This avoids the need for the clips 54, which can therefore be omitted.

Sockets without an earth terminal are widely used in the USA and for such sockets a flap with just live and neutral dummy pins would suffice. In embodiments which use dummy pins, a single pin alone may be used for the purpose of securing the flaps in the closed position by way of an interference fit within the socket. The flaps may be spring loaded to ensure that they are biased towards the normally closed position so as to avoid an indeterminate position for the covers. In such a case the dummy pins may be shortened such that they intrude only partially into the socket so as to minimise ingress whilst relying entirely on the force of the biasing spring to keep them in the closed position and prevent easy access to the live parts by a child.

Although the first and second embodiments of FIGS. 2 and 3 are described as being retrofitted to the main body 16 of the socket outlet 10 by replacing an original front plate 14, in fact socket outlets such as that shown in FIG. 1 can be purchased without the front plate 14, and in that case the device of FIGS. 2 and 3 can be fitted ab initio.

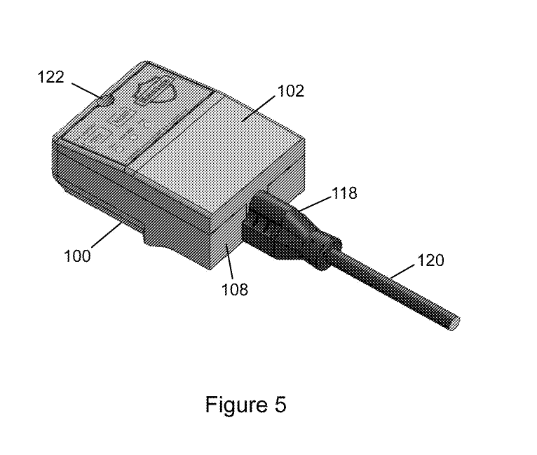

A third embodiment of the invention, FIGS. 4 to 9, provides a protective device which is configurable either as a safety adapter or as a safety plug. When configured as a safety adapter the device may be fitted temporarily or permanently to a socket outlet to protect an otherwise unprotected socket, and provides a substitute socket to receive an unprotected appliance plug. When configured as a safety plug the device is permanently fitted to an otherwise unprotected appliance plug to protect that plug. The protection functionality is essentially the same in each configuration, except that in one case the device is fitted to the socket and in the other case the device is fitted to an appliance plug.

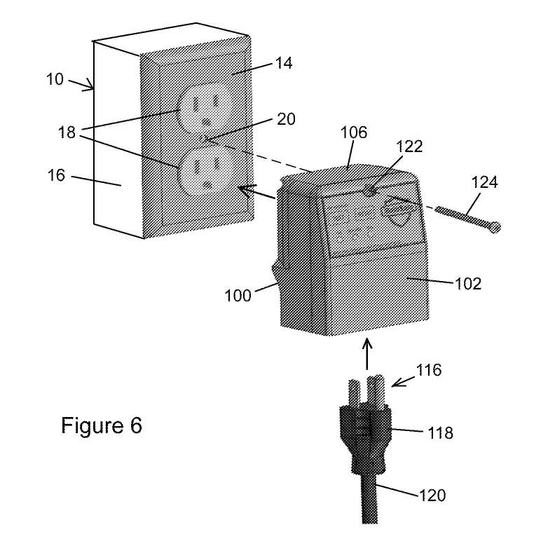

FIGS. 4a and 4b are front and side views, and FIG. 5 is a perspective view, of the third embodiment of the invention configured for use as a safety adapter for a socket outlet 10 of the kind shown in FIG. 1a.

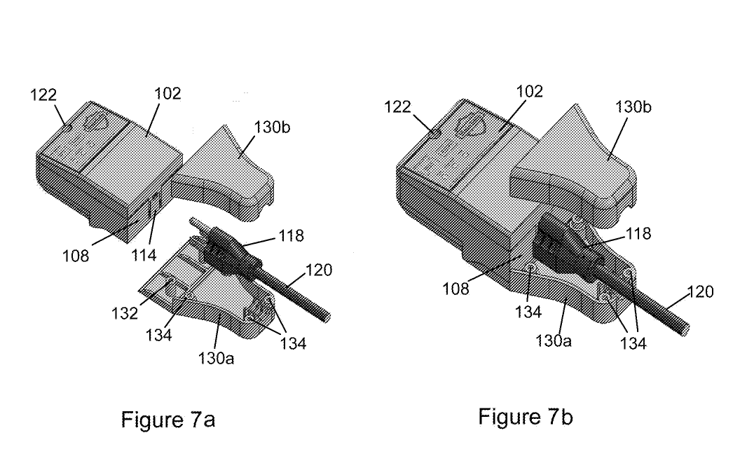

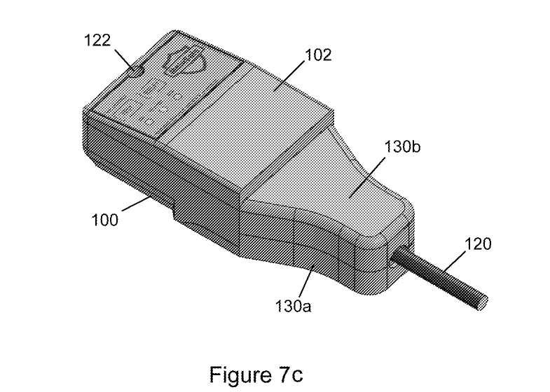

The device comprises a main housing 100 having a front surface 102, a rear surface 104, a top surface 106 and a bottom surface 108. The rear surface 102 has a multi-pin plug 112 for insertion into an electrical socket 18 of the socket outlet 10. The bottom surface 108 has a socket 114 (FIG. 7a) for receiving the terminal pins 116 (FIG. 6) of an electrical plug 118, the plug 118 typically being connected by an electrical cable 120 to an external electrical appliance to be protected. The plug 112 and socket 114 are connected internally of the main housing 100 by a protection circuit such as a GFCI-controlled circuit breaker, an arc fault protector or a surge suppressor, not shown. As seen, the insertion direction of the plug 112 is substantially normal to that of the socket 114 (the insertion direction of a plug is the direction in which the plug is inserted into a complementary socket, and the insertion direction of a socket is the direction in which a complementary plug is inserted into the socket).

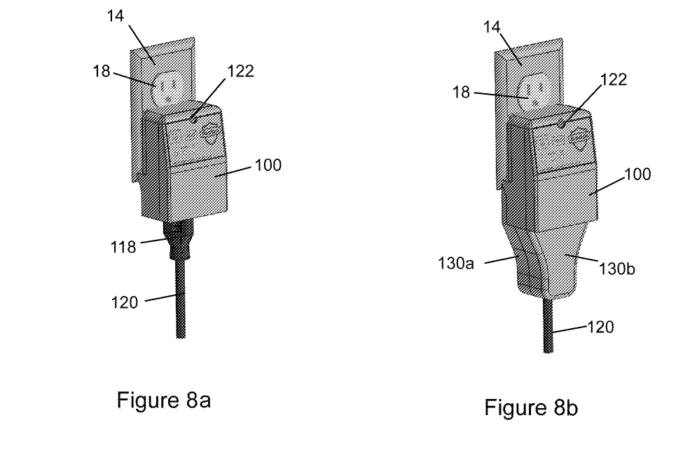

In use as a safety adapter, FIG. 6, the plug 112 is inserted into the lower socket 18 of the socket outlet 10. The main housing 100 has a screw hole 122 running in a front-to-rear direction just below its top surface 106, such hole 122 being axially aligned with the screw hole 20 in the front plate 14 when the plug 112 is fully inserted into the lower socket 18 of the socket outlet 10. Before the plug 112 is inserted into the lower socket 18, the original screw 21 (FIG. 1a) is removed and an extra-long screw 124 is substituted which passes through the hole 122 in the main housing 100 and into the hole 20 so as to secure both the housing 100 and front plate 14 firmly to the main body 16 of the socket housing 12. This screw 124 is also tightened to a grounded plate in the wall-mounted socket outlet 10 to ensure electrical safety, as for the screw 21a in FIG. 3. This fixes the main housing 100 to the socket outlet 10 (FIG. 8a) and provides a substitute safety-protected socket 114 in place of the unprotected lower socket 18 of the outlet 10.

The device may also be configured as a safety plug, FIGS. 7a to 7c. In this configuration the device includes a two-part sub-housing 130a, 130b which is releasably clamped around an appliance plug 118 after the latter is inserted in the socket 114 in the bottom surface 108 of the main housing 100 to optionally enclose the appliance plug and secure said plug against removal from the electrical socket of the main housing. In particular, as shown in FIG. 7b, first the rear part 130b is firmly secured to the rear surface 104 of the main housing 100 by screws (not shown) which are screwed into the housing 100 through a pair of screw holes 132 in the rear part 130a. Then, FIG. 7c, the front part 130b is firmly secured to the rear part 130a by further screws (also not shown) which are screwed into the front part 130b through further screw holes 134 in the rear part 130a. The result is that the appliance plug 18 is fully and permanently enclosed within the sub-housing 130a, 130b. In use the safety plug is simply plugged into the lower socket 18 of the outlet 10, FIG. 8b, the associated appliance being protected by the protection circuit in the main housing 100. Naturally the screw 124 is not normally used in this case, although it could be.

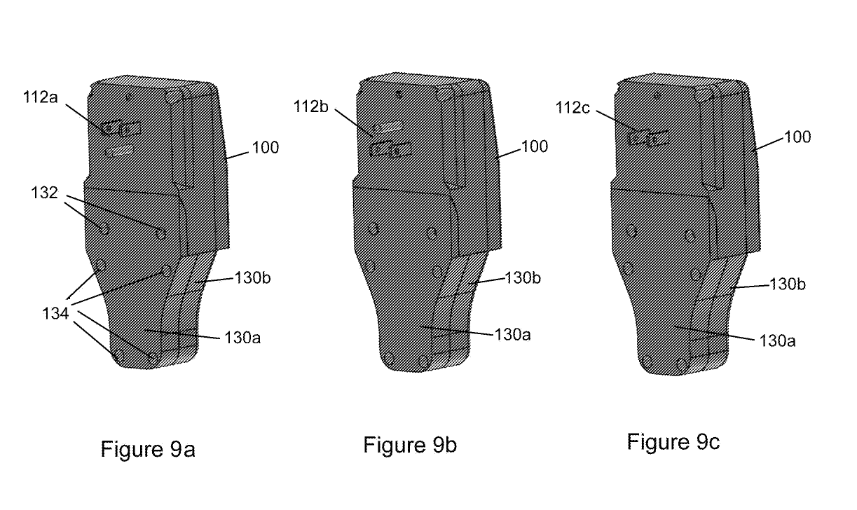

The invention is applicable to both 2-pin and 3-pin devices. For example, in relation to the third embodiment, FIGS. 9a to 9c show different pin arrangements 112a, 112b and 112c corresponding to corresponding different socket arrangements on the socket outlet 10.

Each of the two devices shown in FIGS. 3 and 4 to 9 respectively may have a 2-pin plug 48 or 112 instead of the 3-pin plug 48 or 112 shown. This is shown in FIG. 9(c) for the latter device. Such a device could be used with either a 2- or 3-terminal electrical socket 18 on the wall-mounted socket outlet 10. Prima facie this would restrict the corresponding device socket 50 or 114 to being a 2-terminal socket, corresponding to the 2-pin plug 48 or 112. This is because a 2-pin plug does not provide an earth, and if a 3-terminal device socket 50 or 114 were provided instead of a 2-terminal socket the earth terminal of the socket would be unconnected to ground. However, this might not be appreciated by a user, who might plug a 3-pin appliance plug into the 3-terminal device socket 50 or 114 thinking the earth pin was protected. This disadvantage can be overcome by connecting the screw 21a or 124 internally of the device housing to the earth terminal of the 3-terminal device socket 50 or 114, it being borne in mind that the screw is electrically connected to a grounded plate within the device housing.

The protection circuits contained within the device housings of FIGS. 3 and 4 may comprise a ground fault circuit interrupter, an arc fault protector, a surge suppressor or any other type of electrical protection that can be accommodated within the device housing.

The invention is not limited to the embodiments described herein which may be modified or varied without departing from the scope of the invention.

1. A protective cover plate for fitting to a wall-mounted electrical socket outlet of the kind comprising an open-fronted housing containing at least one electrical socket and which is conventionally fitted with a removable front plate screw-fitted to the open front of the housing and having an opening exposing said socket, the cover plate being screw-fittable to the housing in place of a conventional front plate and likewise exposing said socket, the cover plate including a hinged flap which can be swung over the exposed socket and there releasably secured in place.

2. A protective cover plate as claimed in claim 1, wherein the hinged flap is secured in place by a resiliently deformable clip.

3. A protective device as claimed in claim 1, wherein the hinged flap is held in place by spring-biasing.

4. A protective cover plate as claimed in claim 1, wherein the hinged flap has at least one pin on its inside surface which is brought into approximate alignment with a socket terminal as the flap is swung over and which can be pushed into the socket terminal to fully close the flap.

5. A protective cover plate as claimed in claim 4, wherein the pin is an interference fit in the socket terminal to releasably secure the flap.

6. A protective cover plate as claimed in claim 1, wherein the hinged flap has a gasket on its inside surface for sealing against the socket when the flap is closed.

7. A protective device for fitting to a wall-mounted electrical socket outlet, the protective device including a housing which is screw-fittable to the socket outlet and has a multi-pin electrical plug disposed at a rear surface thereof for engaging a socket of the outlet, the protective device further having a socket disposed at a front surface which is electrically connected to the plug internally of the device housing, the device further including a hinged flap which can be swung over the outlet socket and there releasably held in place.

8. A protective device as claimed in claim 7, wherein the device housing is adapted for fitting to a wall-mounted electrical socket outlet of the kind comprising an open-fronted housing containing at least one electrical socket and which is conventionally fitted with a removable front plate screw-fitted to the open front of the socket outlet housing and having an opening exposing said socket, the protective device being screw-fittable to the socket outlet housing in place of a conventional front plate.

9. A protective device as claimed in claim 7, wherein the hinged flap is held in place by a resiliently deformable clip.

10. A protective device as claimed in claim 7, wherein the hinged flap is held in place by spring-biasing.

11. A protective device as claimed in claim 7, wherein the hinged flap has at least one pin on its inside surface which is brought into approximate alignment with a socket terminal as the flap is swung over and which can be pushed into the socket terminal to fully close the flap.

12. A protective device as claimed in claim 11, wherein the pin is an interference fit in the socket terminal to releasably secure the flap.

13. A protective device as claimed in claim 7, wherein the hinged flap has a gasket on its inside surface for sealing against the socket when the flap is closed.

14. A protective device as claimed in claim 8, including a gasket for sealing the rear surface of the device to the front edge of the housing.

15. A protective device as claimed in claim 7, wherein the device housing includes a ground fault circuit interrupter, an arc fault protector, a surge suppressor or other protection circuit.

16. A protective device for use with a wall-mounted electrical socket, the protective device comprising a main housing having a multi-pin electrical plug disposed at a first surface for insertion into said wall-mounted electrical socket and an electrical socket disposed at a second surface for receiving an appliance plug, said device plug and socket being connected internally of the main housing by a protection circuit, the main housing further having a screw hole extending therethrough which is axially aligned with a screw hole in the wall-mounted electrical socket when the multi-pin electrical plug disposed at said first surface is fully inserted into the wall-mounted electrical socket, thereby to allow the main housing to be optionally secured to the wall-mounted socket by a screw passing through the main housing into the socket, the protective device further including a sub-housing which is releasably fittable to the main housing to optionally enclose the appliance plug and secure said plug against removal from the electrical socket of the main housing.

17. A protective device as claimed in claim 16, wherein the electrical plug disposed at the first surface has two pins, wherein the electrical socket disposed at the second surface has three terminals, and wherein when present the screw is in contact with both a grounded member within the main housing and with the earth terminal of the three-terminal socket.

18. A protective device as claimed in claim 16, wherein the main housing has a top surface, a bottom surface, and front and rear surfaces, wherein the electrical plug is disposed at the rear surface and the electrical socket is disposed at the bottom surface, such that the insertion direction of the plug is substantially normal to the insertion direction of the socket.

19. A protective device as claimed in claim 16, wherein the protection circuit comprises a ground fault circuit interrupter, an arc fault protector or a surge suppressor.
